(19) United States
(12) Patent Application Publication
(10) Pub. No.: US 2006/0095557 A1
(43) Pub. Date: May 4, 2006

(54) Testing a data communication architecture

(76) Inventors: Gregg Bernard Lesartre, Ft. Collins, CO (US); Craig William Warner, Addison, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/935,624

(22) Filed: Sep. 7, 2004

(51) Int. Cl. G06F 15/173

(52) U.S. Cl. 709/224

(57) ABSTRACT

A method, system, and apparatus for testing a scalable computer system is provided. In an illustrative implementation, the system comprises a first buffer, a sequence stored in the first buffer, and a state controller for monitoring a communications link for a trigger signal. Upon detection of the trigger signal, the state controller causes the sequence stored in the first buffer to be inserted in the link.

### BACKGROUND

Computing architectures that operate efficiently and that can process large volumes of data quickly are often preferred over their counterparts. Additionally, it is often desired to operate a variety of tasks, using a variety of computer resources, simultaneously within a computer system. Accordingly, developing complex multiprocessor systems has been the subject of significant of research.

A number of data communication architectures have been developed in order to facilitate communications between cooperating components within a computer system. Various types of equipment can be used as computer components, each requiring data communication. For example, a computer system may comprise a plurality of processors, data storage units, printers, monitors, etc. A number of data communication architectures currently exist to communicate data between computer components. For example, SCSI (Small Computer Systems Interface), IDE/ATA (Integrated Drive Electronics/Advanced Technology Attachment), USB (Universal Serial Bus) are common architectures used to communicate between processors, hard drives, CD-ROMs, serial data ports, etc.

These existing data communication architectures have been effective in creating a means to communicate between cooperating computer components; however, none of them are specifically designed to handle very high volumes of data at high clock frequencies (e.g., several Gigahertz). As a result of the need for higher bandwidth data communications, new communication architectures have been implemented to allow for high speed serial communications. One example is the SERDES (serializer/deserializer) data communication architecture. SERDES uses an encoder to encode data and then communicates it over one or more communication channels to a decoder for a corresponding decoding process. This architecture has proven to be an effective means to increase data communication bandwidth between cooperating computer components.

The development of high speed communication architectures has made it possible for system designers to create large, scalable computer systems. Systems such as the Superdome® system by Hewlett-Packard (Palo Alto, Calif.) have been created that contain numerous processors that can be configured or partitioned into several independent sections in order to allow for each component to undertake different tasks. The amount of applications, tasks, computations, etc. that can be performed by one computer system continues to grow as the size and complexity of larger, scalable computer systems such as the Superdome® system increases.

One obstacle in the development of complex scalable systems is the difficulty in verifying design parameters and conducting efficient testing of the system. The complexity of these systems as well as the complicated nature of the communication protocols used in them makes these systems difficult to thoroughly test.

### SUMMARY

A method, system, and apparatus for testing a scalable computer system is provided. In an illustrative implementation, the system comprises a first buffer, a sequence stored in the first buffer, and a state controller for monitoring a communications link for a trigger signal. Upon detection of the trigger signal, the state controller causes the sequence stored in the first buffer to be inserted into the link.

### BRIEF DESCRIPTION OF THE DRAWINGS

For the purpose of illustrating the invention, there is shown in the drawings one exemplary implementation; however, it is understood that this invention is not limited to the precise arrangements and instrumentalities shown.

FIG. 1 is a block diagram illustrating an exemplary computer system upon which one implementation of the present invention can operate.

FIG. 2 is a diagram illustrating an exemplary configuration of a system as shown in FIG. 1 having a single cell partition upon which one implementation of the present invention can operate.

FIG. 3 is a diagram illustrating the components contained in an exemplary cell used for the injector cell.

FIG. 4 is a diagram illustrating the components contained in an exemplary cell used for the receiving cell.

FIG. 5 is a flow chart illustrating one embodiment of the steps processing performed by an exemplary data communications architecture when injecting a packet into the system fabric.

FIG. 6 is a flow chart illustrating a second embodiment of the steps involved in an exemplary packet injection process accordance with the present invention.

### DETAILED DESCRIPTION

Overview

Current scalable computer systems or networks may include numerous processing units using complicated protocols for communication. Such systems can contain many types of devices, such as processors, peripheral devices (e.g., printers, keyboards, disk drives), display devices and display controllers, memory devices (e.g., RAM, ROM), etc. Often it is desired to enable the various elements of the system to communicate freely between each other, while other times it is preferred that some elements be completely isolated from other element to avoid potential interference as well to reduce possible security concerns. As a result, configuration of scalable computer systems is often a complicated task.

Once a system design has been constructed, it is preferred that the system can be thoroughly tested prior to deployment. This, however, can be a difficult task. Typically, in order to stress system designs, test programs are used to perform certain tasks and evaluate system performance. Some functions are extremely difficult, or impossible, to test in this manner. Design parameters involving very large system configurations, error detection procedures, and error recovery operations are among the more difficult system functions to verify. For example, it is difficult to test the system response to a damaged piece of hardware. Damaged hardware can send data into the system that is distinct from data that would occur during normal operations. One method to test such cases has been to create a custom piece of hardware representative of a damaged piece of equipment (e.g., a chip with a broken or missing pin) to simulate the possible system conditions. This solution, however, is generally not a practical means to test all possible conditions.

Illustrative Computing Environment

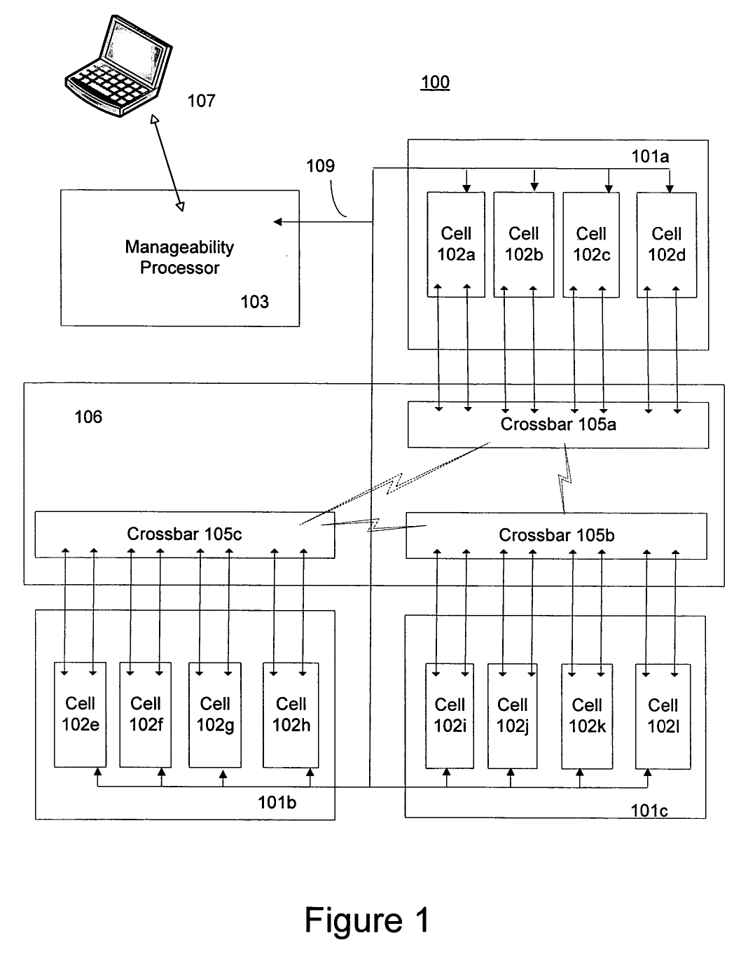

Referring to FIG. 1, an exemplary computing system 100 on which the system and method described herein can operate is shown. FIG. 1 illustrates a partitionable computer system that includes a plurality of elements or cells. Each cell or group of cells is capable of operating as a separate system, and can be associated with various other devices, such as input/output devices (e.g., keyboards, printers, display devices). One example of a system as illustrated in FIG. 1 is the Superdome® system by Hewlett-Packard (Palo Alto, Calif.). In the illustrated embodiment, three partitions 101a, 101b, 101c are shown. Each partition comprises a plurality of cells 102a-102l. Each cell has the ability of communicating with every other cell within the system, either by direct connection or via a routing device such as a crossbar switch or other similar device capable of routing packets. In the exemplary embodiment, the routing device comprises a plurality of crossbars 105a, 105b, 105c.

The series of routing devices (e.g., the crossbars 105a, 105b, 105c) is referred to collectively as a switch fabric 106. The switch fabric 106 allows packets to be communicated from an originating cell (i.e., the source address) to a destination cell (i.e., the destination address). For example, in the exemplary embodiment illustrated in FIG. 1, three crossbar devices 105a, 105b, 105c are shown, which collectively comprise switch fabric 106. The crossbar device can communicate with a number of cells, as well as with the other crossbar devices. For example, the four cells 102a, 102b, 102c, 102d located in partition 101a can communicate directly with the crossbar 105a that is directly coupled to them. The same scenario exists for the cells located in the remaining partitions. The cells are capable of communicating with the crossbar directly coupled to it. A cell in the first partition (e.g., partition 101a) can also communicate with a cell located in a different partitions (e.g., partition 101c) via the switch fabric 106. Data originating at a cell in one partition (e.g., cell 102a in partition 101a) can be sent to the crossbar device coupled to the partition (i.e., crossbar 105a) and then forwarded across the fabric 106 to a destination cell coupled to another crossbar device (e.g., cell 102h in partition 101c coupled to crossbar 105c).

The partitions are a logical separation from the remainder of the system. A partition may reside on a different physical device, or it may reside on the same physical device as one or more other partitions. A partition may be dedicated to performing a specific computer function. The functions may be related (e.g., multiple functions required by a single application) or they may be unrelated (e.g., two different operating systems running two separate applications). Additionally, at any given moment, cells may exist within the computer system 100 that are idle. In one embodiment, at least one idle or spare cell may be configured into a partition to be available in case of a failure occurring in one of the used cells, analogous to a spare tire carried in an automobile.

Data communication across the exemplary system shown in FIG. 1 is conducted using a “packet” format. A packet carries some amount of information, and may comprise one or more smaller packets. For example, a packet may comprise a header packet followed by some number of small data packets. The header packet is often used to describe the type of information contained within the packet or to provide information regarding how to handle the packet, such as the destination address of the packet. By way of example, the system described herein uses packets comprising eight logical bits that are transmitted in a ten bit encoding protocol, known as 8B10B encoding. However, it is understood that other transmission protocols could also be employed.

Injection of Test Sequence on Communications Link

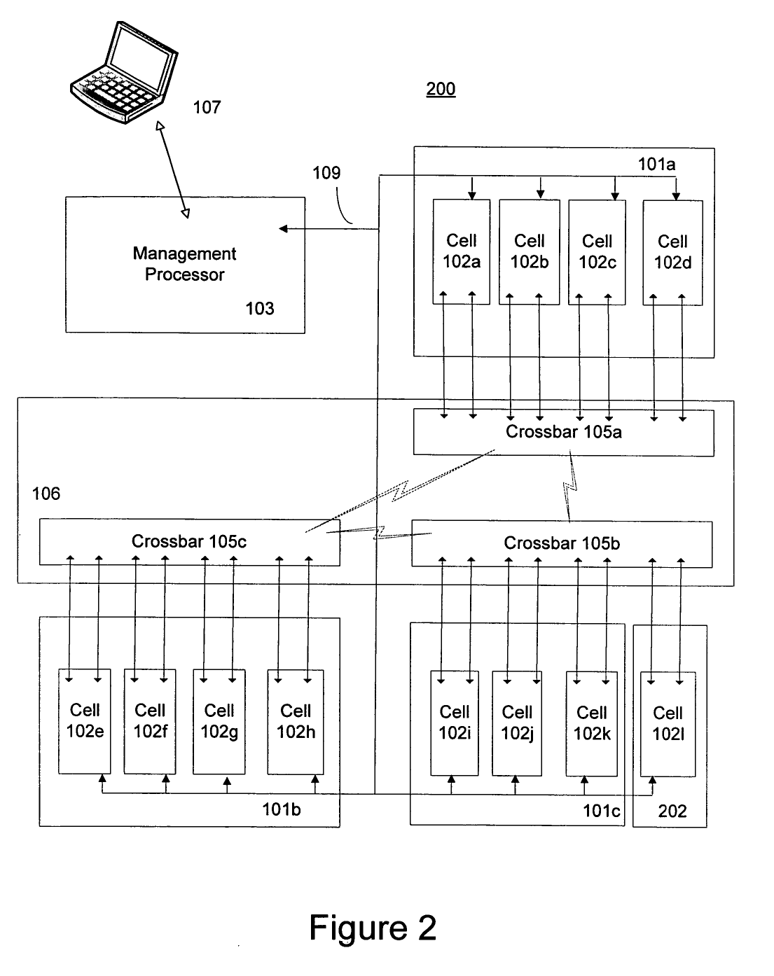

Referring to FIG. 2, the configuration of a computer system in accordance with one implementation of the present invention is shown. In the exemplary implementation, a single cell injection partition 202 is configured on the computer system 200. The configuration process is typically performed by a system designer by accessing the system via a management processor 103. The management processor can contain a graphical user interface 107 to allow the system designer to enter configuration information into the system. The management processor 103 sends the configuration information to the cells, typically via a USB connection to other cells. In an exemplary embodiment, executable code is sent to the processor 103. The code is run on the processor 103 to set up partition configuration and provide routing information. This process tells the cells how the partitions are to be created.

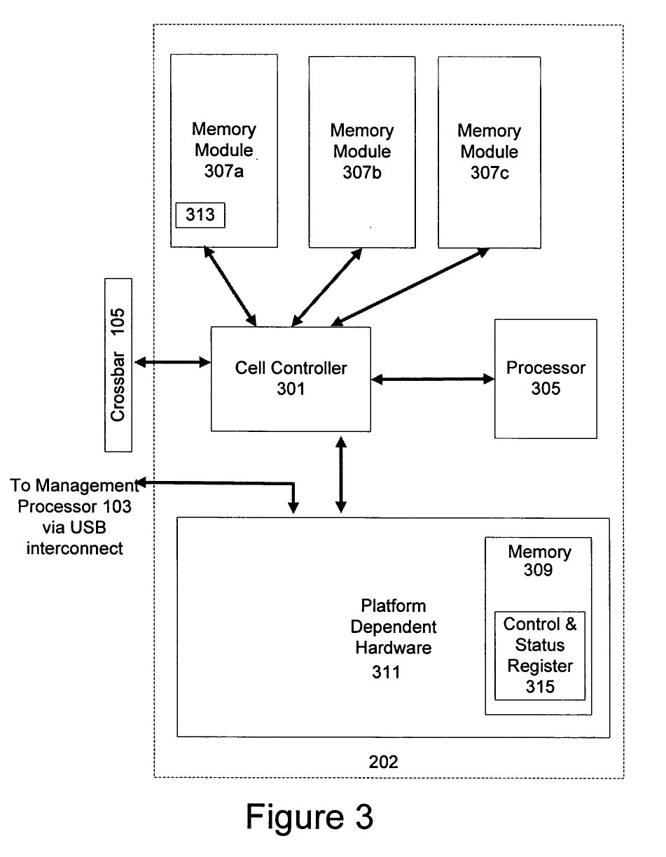

FIG. 3 illustrates the contents of a cell that is configured to inject packets into the system fabric via a communications link, referred to hereafter as the “injector cell.” In an exemplary embodiment, injector cell 202 comprises a cell controller 301. The cell controller 301 is in communication with the system fabric via crossbar 105. Additionally, cell controller 301 is coupled within injector cell 202 to a state control processor 305 and one or more memory modules 307a, 307b, 307c. In the illustrated embodiment, a single state control processor 305 resides within the injector cell 202. It is, however, understood that the injector cell 202 may contain a plurality of processors and various numbers of memory modules. Additional platform dependent hardware 311 may also reside within the cell. In an exemplary embodiment, the platform dependent hardware 311 communicates with the management processor via a USB interconnect. The configuration information that creates the one cell partition is stored in a memory 309 located on the platform dependent hardware 311. In an exemplary embodiment, a control and status register 315 resides in the memory 309 on the platform dependent hardware 311 to store the configuration information.

The memory modules 307a, 307b, 307c enable the creation of various buffers and I/O modules in a cell. In the embodiment illustrated in FIG. 3, a first buffer 313 resides in memory module 307a. It is understood, however, that various numbers of buffers can be created. The first buffer 313 may be used to store a sequence comprising one or more packets, as more fully described below.

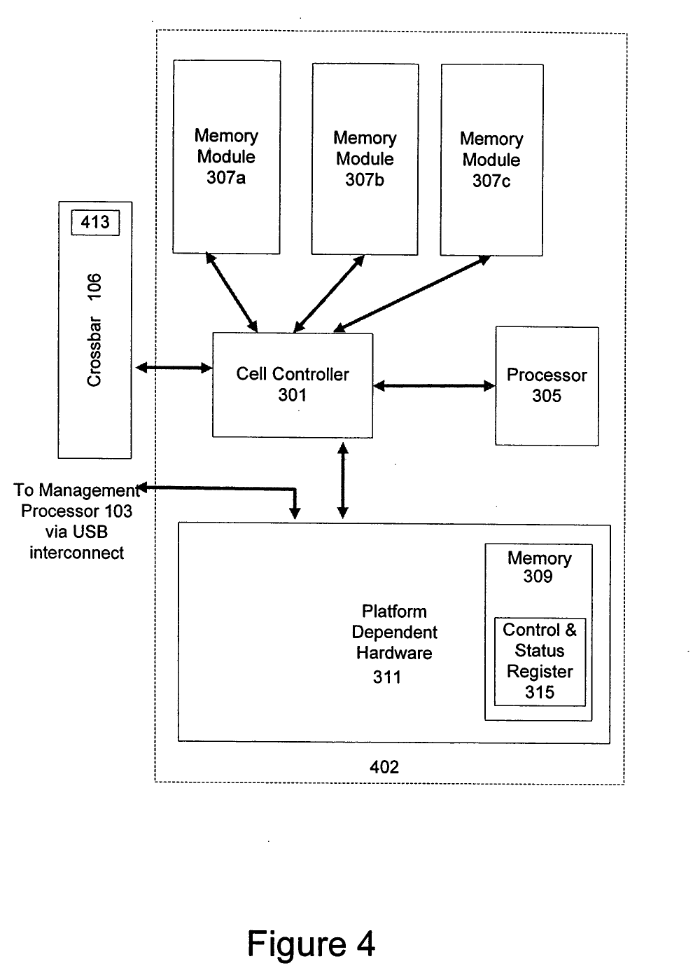

FIG. 4 illustrates an exemplary destination cell 402 located on the opposite or destination end of a communications link. The destination cell 402 may have a similar configuration as the cell shown in FIG. 3. Such a configuration is merely exemplary, as other configurations would be apparent to one of skill in the art. The destination cell 402 is linked to the system fabric 106 via a crossbar. The crossbar may contain a response buffer 413. Response buffer 413 may be used to store packets generated in response to packets sent from the injector cell.

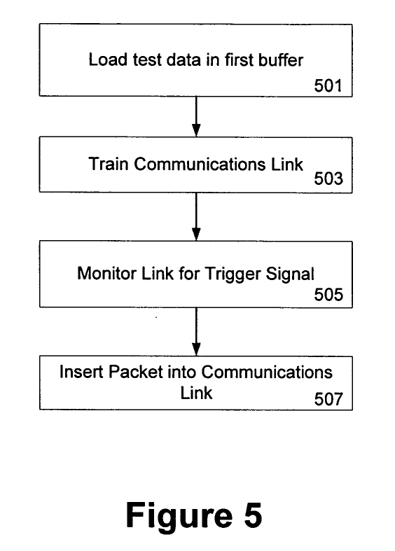

FIG. 5 illustrates the steps involved in an exemplary implementation of the present invention. A first buffer is loaded with a test data sequence (501). A training process is performed to establish a communications link (503). The link is monitored for a trigger signal, typically by a state controller (505). Upon detection of the trigger signal, the sequence stored in the first buffer is communicated into the communications link (509).

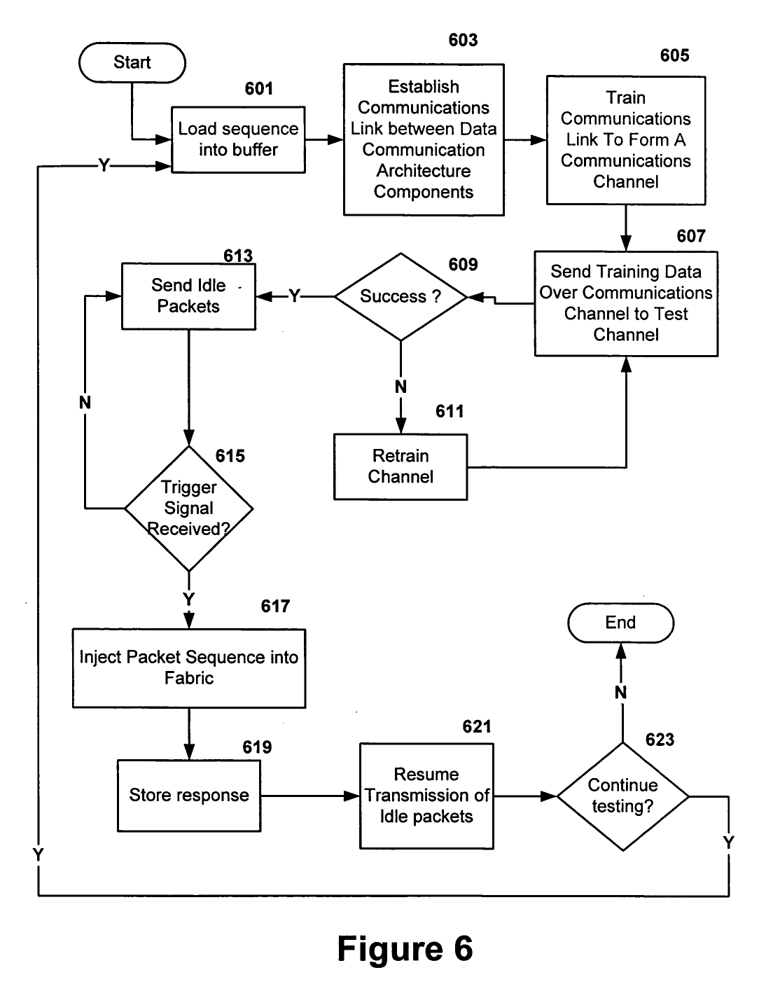

FIG. 6 shows a more detailed illustration of an exemplary method in accordance with the present invention. The injector cell 202 may be used to inject a sequence of at least one packet into the system fabric. A test sequence comprising one or more packets is generated and stored in a buffer (601). The packet or packets can be generated using software running on the processor residing within the one cell injection partition, or alternatively software for generating test packets can operate remotely and one or more packets can be communicated to the buffer in the injector cell. Additionally, the test packet or packets can be manually created by the test administrator. In the exemplary embodiment, the format of the sequence can be in either encoded 10 bit format or un-encoded 8 bit format.

Before a packet is injected, at least one communications link between various data communications architecture components is established (603). The link or links are trained to form a communications channel (605). Training data is sent over the link to test the channel (607). A check is performed to determine if the training data successfully reached its destination (609). If the training data has not successfully reached the destination cell, the training process is repeated (611).

Once the link is trained, a series of idle or invalid packets is continuously sent across the link after the link is initialized (613). An invalid packet is normally a packet that is intended to be dropped by the receiving end of the link as invalid, while an idle packet is normally a packet that is received by the receiving end of the link and reported to the internal logic on the receiving end to indicate that the link resides in a idle or waiting condition. By sending invalid or idle packets, the link is maintained in an idle yet available status. For the purposes of this disclosure, the term idle packets refers to either invalid packets or idle packets.

The sequence of one or more packets in the buffer is not communicated across the link until a trigger signal is received. The trigger signal may be generated by internal logic residing with the sending cell or the receiving cell (e.g., using a performance counter or embedded logic analyzer) or alternatively the trigger signal may be generated externally and input to the system (e.g., by asserting a signal on an input/output component).

The receipt of the trigger signal (615) indicates to the injector cell to inject the sequence stored in the buffer. The machine state controller in the one-cell injector partition causes the sequence to be communicated to the receiving cell via the system fabric. The sequence stored in the buffer is communicated across the link (617). Any response generated on the receiving end is stored in a response buffer, typically located on a crossbar switch on the opposite end of the communications link from the injector cell (619). The contents of the response buffer can be read by the internal logic to evaluate whether the system is operating as expected.

After the packet sequence is injected into the system fabric, the injector cell again sends idle or invalid packets (621). If further testing is desired (623), the inject buffer can be loaded with another test sequence (611) for testing another operation or another location. The process can then be repeated upon receipt of another trigger signal.

A record of responses stored in the response buffer can be compiled in a report and output via the GUI interface (shown as 107 in FIG. 2) if desired. Alternatively, a message may be generated to the GUI interface only if an unexpected result is received. For example, packets requesting a response may be directed to a location in the system that is protected by a firewall. No response is expected, as the packet should be discarded by the firewall, but a message would be provided to the GUI interface if a response is received.

Using this technique, various types of packets can be injected into the system. Normal operating packets can be injected to simulate various operating conditions. Injecting normal operating packets allows for system designers to verify system performance under various conditions. For example, the routing between any two points can be tested by injecting a packet that appears to the victim cell to have originated at a point in the system other than the injector cell. Abnormal packets can also be injected. Abnormal packets can be used to simulate conditions, for example, that otherwise occur if a hardware component has failed. For example, a damaged hardware component (e.g., a chip with a broken pin) may cause packets to be sent that are of an abnormal nature (e.g., containing undefined or missing bits). Packets of this nature were previously not able to be inserted into the system fabric by means of intentionally damaged hardware elements. Using a one-cell injector partition allows for such abnormal packets to be inserted into the system fabric without the need for custom hardware, and the response to such packets can be monitored.

The system described herein can also be used to verify the effectiveness of firewall partitions. Packets can be created both of the type that should be allowed to pass through the firewall as well as of the type that should be rejected by the firewall. Injecting these packets into the system fabric will allow the system designer to determine if the firewall is blocking the desired packets.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A method of testing a data communication architecture comprising:
loading a first buffer with a sequence;
training a communications link;
monitoring said link for a trigger; and
upon detection of said trigger, inserting said sequence into said link.

2. The method as set forth in claim 1, further comprising:
receiving said sequence; and
storing a response to said sequence in a second buffer.

3. The method as set forth in claim 1, further comprising sending idle packets before detection of said trigger.

4. The method as set forth in claim 1, further comprising sending idle packets after detection of said trigger.

5. The method as set forth in claim 1, wherein said sequence comprises one or more data packets.

6. The method as set forth in claim 2, further comprising outputting the said response stored in said second buffer to a user interface.

7. A system for testing a data communication architecture comprising:
a first buffer;
a sequence stored in said first buffer; and
a state controller for monitoring a communications link for a trigger signal,
wherein said state controller causes said sequence stored in said first buffer to be inserted in said link upon detection of said trigger.

8. A system as set forth in 7 further comprising a second buffer residing on destination cell for storing a response to said sequence received via said communications link.

9. A system as set forth in claim 7, wherein said sequence comprises one or more data packets.

10. A system as set forth in claim 9, wherein said one or more data packets are representative of malfunctioning hardware equipment.

11. A system as set forth in claim 7, wherein said sequence is generated via software.

12. A system as set forth in claim 8, further comprising an interface for outputting the contents of said second buffer.

13. A system for testing a data communication architecture comprising:
means for storing a test sequence;
means for monitoring a communication link for a trigger signal; and
means for inserting said sequence in said link.

14. A system as set forth in claim 13, further comprising means for storing a response to said sequence following said insertion in said link.

15. A system as set forth in claim 14, further comprising means for outputting the contents of said storing means.

16. A system as set forth in claim 13, wherein said test sequence comprises one or more packets.

17. A scalable computer network comprising:
a communications link between a partition and a location in a system fabric;
a first buffer contained in said partition;
a sequence stored in said first buffer;
a state controller in said partition, said state controller capable of monitoring said communications link for a trigger signal, wherein said sequence stored in said buffer is inserted in said communications link upon detection of said trigger signal by said state controller.

18. The network as set forth in claim 17, further comprising a second buffer in said system fabric, wherein a response to said sequence is stored in said second buffer.

19. The network as set forth in claim 17, wherein said sequence comprises one or more packets.
